(19) United States
(12) Patent Application Publication
(10) Pub. No.: US 2003/0162456 A1
(43) Pub. Date: Aug. 28, 2003

(54) Air permeable porous fiber pad and the method of making it

(76) Inventor: Jung-Fu Chien, Pan Chiao City (TW)

Correspondence Address: PRO-TECHTOR INTERNATIONAL, 20775 Norada Court, Saratoga, CA, 95070-3018, US

(21) Appl. No.: 10/085,207

(22) Filed: Feb. 26, 2002

(51) Int. Cl. B32B 5/12; D04H 1/00; D04H 3/00; D04H 5/00; D04H 13/00; D02G 3/00

(52) U.S. Cl. 442/327; 428/105; 428/369; 442/352

(57) ABSTRACT

The present invention relates to a air permeable porous fiber pad and a method for making a air permeable porous fiber pad. A single-layer or multi-layer web may be cut by at least two sets of belt rollers, thereby forming strip-shaped webs whose width is the same as the belt. The at least two sets of belts may divide the parallel juxtaposed strip-shaped webs into spaced layers. At least two sets of rollers whose center of shaft is adjustable may be used to adjust the position of each layer of strip-shaped web, so that the layers of strip-shaped webs may overlap each other, and the overlapped layers of strip-shaped webs may be conveyed into a crosslapper, thereby making a air permeable porous fiber pad.

### BACKGROUND OF THE INVENTION

1. Field of the Invention

The present invention relates to a air permeable porous fiber pad and the method for making the a air permeable porous fiber pad, and more particularly to a air permeable porous fiber pad that may efficiently save the usage amount of the fiber material, and may enhance the air permeability of the fiber pad product that is compressed by the user sitting or laid down on it.

2. Description of the Related Art

A conventional fiber pad made of fiber material are widely be used to make a product such as a pillow, seat cushion, bed cushion, outdoor furniture, and packaging material. However, the conventional fiber pad usually has a solid structure, so that when the fiber pad is under load or compressed by the user, the room between the fibers is compacted, thereby greatly decreasing the air permeability of the fiber pad product that is compressed by the user, so that user easily to feel hot or have an uncomfortable sensation.

### SUMMARY OF THE INVENTION

The present invention has arisen to mitigate and/or obviate the disadvantage of the conventional fiber pad.

The primary objective of the present invention is to provide a air permeable porous fiber pad and the method for making the a air permeable porous fiber pad that may efficiently save the usage amount of the fiber material, wherein the conventional fiber pad has a solid structure.

Another objective of the present invention is to provide a air permeable porous fiber pad and the method for making the a air permeable porous fiber pad that may enhance the air permeability of the fiber pad product that is compressed by the user.

In accordance with one aspect of the present invention, there is provided a air permeable porous fiber pad, comprising:

a single-layer or multi-layer web, the web is cut by at least two sets of belt rollers, thereby forming strip-shaped webs whose width is the same as the belt, the at least two sets of belts may divide the parallel juxtaposed strip-shaped webs into spaced layers, at least two sets of rollers whose center of shaft is adjustable may be used to adjust the position of each layer of strip-shaped web, so that the layers of strip-shaped webs may overlap each other, and the overlapped layers of strip-shaped webs may be conveyed into a crosslapper, thereby making a air permeable porous fiber pad.

In accordance with another aspect of the present invention, there is provided a method for making a air permeable porous fiber pad, comprising the steps of:

letting a single-layer or multi-layer web to be passed through and cut by at least two sets of belt rollers, thereby forming strip-shaped webs whose width is the same as the belt; the at least two sets of belts may divide the parallel juxtaposed strip-shaped webs into spaced layers, at least two sets of rollers whose center of shaft is adjustable may be used to adjust the position of each layer of strip-shaped web, so that the layers of strip-shaped webs may overlap each other, and the overlapped layers of strip-shaped webs may be conveyed into a crosslapper, thereby making a air permeable porous fiber pad.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a air permeable porous fiber pad in accordance with a preferred embodiment of the present invention;

FIG. 2 is a schematic view of a air permeable porous fiber pad in accordance with a preferred embodiment of the present invention;

FIG. 3 is a perspective view of webs of a air permeable porous fiber pad in accordance with the preferred embodiment of the present invention;

FIG. 4 is a flow chart of a air permeable porous fiber pad in accordance with a preferred embodiment of the present invention; and

FIG. 5 is a flow chart of a air permeable porous fiber pad in accordance with another preferred embodiment of the present invention.

### DETAILED DESCRIPTION OF THE INVENTION

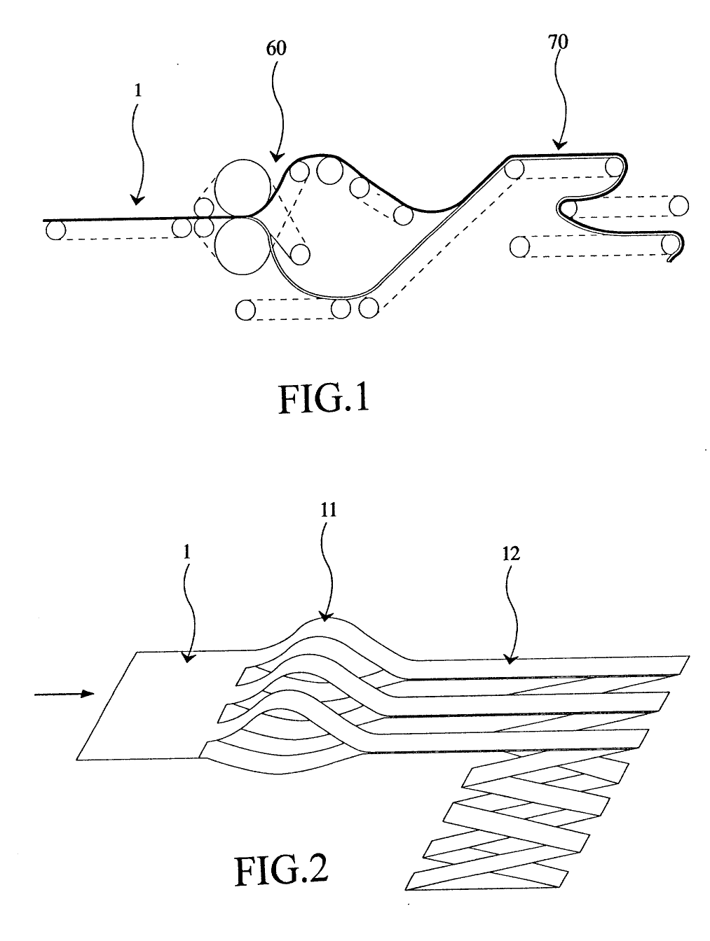

Referring to the drawings and initially to FIGS. 1 and 2, a method for making a air permeable porous fiber pad in accordance with a preferred embodiment of the present invention comprises the following steps.

First, a single-layer web 1 is processed by slicing and overlaying 60. The single-layer web 1 is initially slicing regularly, thereby forming the webs after being divided, wherein the dividing width may be adjusted according to the practical requirements. Then, the webs 11 may be overlapped, and the gap between the overlapped webs 11 may be adjusted, thereby forming the webs 12 after being overlapped.

The method of the present invention may also use a multi-layer web to make a air permeable porous fiber pad in the same manner.

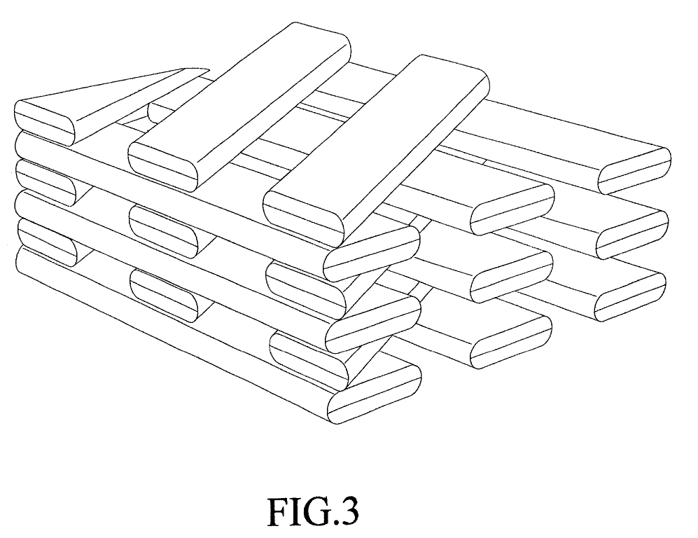

Then, the webs 12 after being overlapped may be conveyed into a crosslapper to be processed by crosslap 70, thereby making fiber pads (as shown in FIG. 3) which are like knitting nets. The thickness and support force of the fiber pad are formed by the intersecting corsslapped webs after being overlapped. The gaps of the meshes of the intersecting structure are formed by the intersecting gaps of the overlapped webs, thereby forming the fiber pad having a porous structure. The fiber pad having a porous structure may be used to make a product such as a pillow, seat cushion, bed cushion, outdoor furniture, and packaging material. Thus, the present invention may efficiently save the usage amount of the fiber material (the conventional fiber pad has a solid structure), and may enhance the air permeability of the fiber pad product that is compressed by the user.

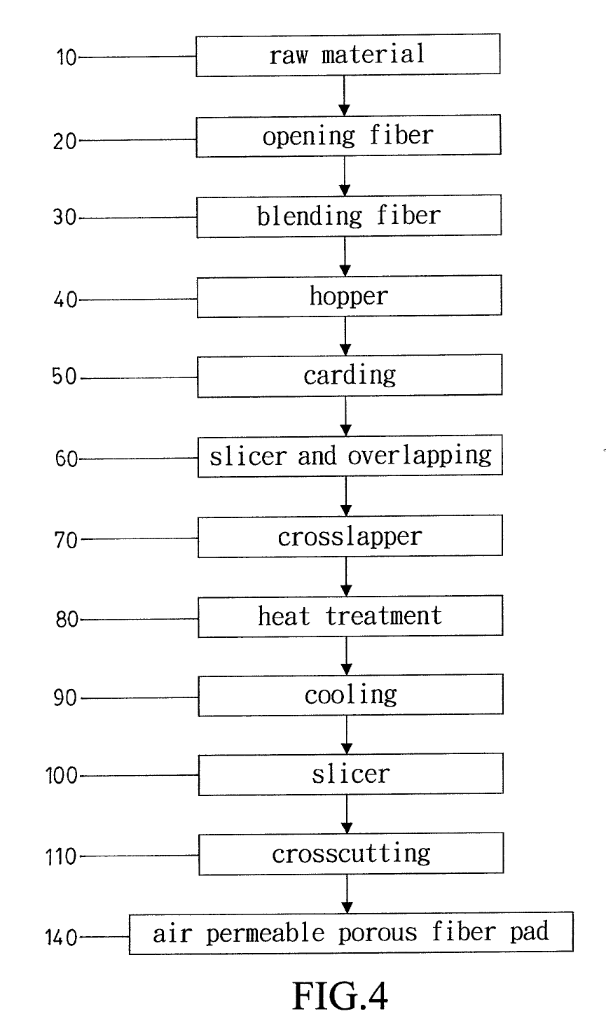

As shown in FIG. 4, the flow chart of the method for making a air permeable porous fiber pad in accordance with a preferred embodiment of the present invention is shown. The primary fiber of the air permeable porous fiber pad in accordance with the present invention includes a natural fiber containing cotton, linen, wool, silk and coconut fiber a chemical fiber containing PET, PE, PP and PA, or a mineral fiber containing carbon fiber, mineral fiber and glass fiber.

The primary fiber of 55% to 85% may be mixed with the heat-melted fiber of 15% to 45%, thereby forming the raw material 10. The raw material 10 may then be processed by opening fiber 20, blending fiber 30, hopper 40, carding 50, slicer and overlapping 60, crosslapper 70, heat treatment 80, cooling 90, slicer 100, and crosscutting 110, thereby finally making the air permeable porous fiber pad 140.

The slicer machine used in the slicer process includes (but not limited to) a slicer machine similar to a slicer used in spinning mill machine. The conditions of each step in the process may be set according to the practical requirements, wherein the heat treatment may use the oven. The heat-melted fiber may added into the raw material before the heat treatment, so that the webs of each layer may be bonded securely to form the fiber pad.

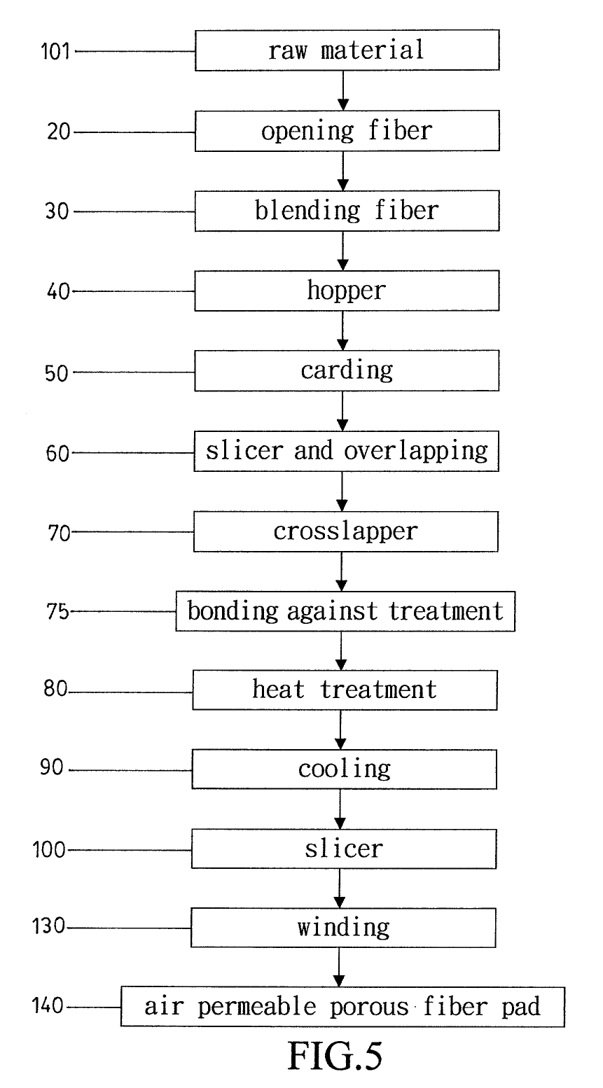

As shown in FIG. 5, the flow chart of the method for making another air permeable porous fiber pad in accordance with a preferred embodiment of the present invention is shown.

The primary fiber (the same as that as shown in FIG. 4) of 55% to 85% may be used as the raw material 101 without the heat-melted fiber. The raw material 101 may then be processed by opening fiber 20, blending fiber 30, hopper 40, carding 50, slicer and overlapping 60, crosslapper 70, bonding agent treatment 75, heat treatment 80, cooling 90, slicer 100, and winding 130, thereby finally making the air permeable porous fiber pad 140.

The steps in the process are the same as that as described in FIG. 4, wherein the bonding agent treatment 75 may proceed a top side spraying and a bottom side spraying, or dipping resin material of 15% to 45%. Then, the webs of each layer may be bonded securely in the heat treatment to form the fiber pad.

The present invention may also use a crimped tow as the raw material The crimps is opened through the air, so that the crimps between the single filaments may be separated, thereby increasing the lofty capacity of the tows (not shown). Then, the tows may be spaced in parallel with each other and may be conveyed into the crosslapper, to be processed by the steps of the bonding agent treatment and cooling. The crimped tow may be cut in the process, thereby forming the crimped staple. The crimps of the crimped tow is exactly same as crimps of staple fiber, so that they are lofty and resilient as the staple fiber pad.

In the method for making another air permeable porous fiber pad in accordance with a preferred embodiment of the present invention, the steps of slicing overlapping crosslapping, drawing and crosslap are further described in detail as follows.

The webs that have been processed by the steps of opening fiber 20, blending fiber 30, hopper 40, carding 50, may pass through a slicer machine consisting of two sets of belt rollers, thereby cutting the web into strip-shaped webs whose width is the same as the belt. The two sets of belts may divide the parallel juxtaposed strip-shaped webs into an upper layer and a lower layer. A roller whose center of shaft is adjustable may be used to adjust the transverse position of the upper layer of strip-shaped web, so that the upper layer of strip-shaped web may overlap on the lower layer of strip-shaped web. Then, the overlapped upper and lower layers of strip-shaped webs may be conveyed into the crosslapper.

The slicing width of the slicer machine may be adjusted by adjusting the width of the belt. At least two sets of belt rollers may divide the parallel juxtaposed strip-shaped webs into spaced layers. Then, multiple sets of rollers whose center of shaft is adjustable may be used to adjust the transverse position of each layer of strip-shaped web, so that the layers of strip-shaped webs may overlap each other. Then, the overlapped strip-shaped webs may be conveyed into the crosslapper, and may then be processed by the steps of heat treatment and cooling, thereby making a air permeable porous fiber pad.

The web using the heat-melted fiber may be processed by needle punching or water entangling after the crosslap step.

The present invention also relates to a air permeable porous fiber pad including a single-layer or multi-layer web that that have been processed by the steps of opening fiber, blending fiber, hopper, and carding. The web is cut by two sets of belt rollers, thereby forming strip-shaped webs whose width is the same as the belt. The two sets of belts may divide the parallel juxtaposed strip-shaped webs into an upper layer and a lower layer. Two sets of rollers whose center of shaft is adjustable may be used to adjust the transverse position of the strip-shaped web, so that the upper layer of strip-shaped web may overlap the lower layer of strip-shaped web. Then, the overlapped upper and lower layers of strip-shaped webs may be conveyed into the crosslapper, and may then be processed by the steps of heat treatment and cooling, thereby making a air permeable porous fiber pad.

The present invention also relates to a air permeable porous fiber pad including a single-layer or multi-layer web that that have been processed by the steps of opening fiber, blending fiber, hopper, and carding. The web is cut by at least two sets of belt rollers, thereby forming strip-shaped webs whose width is the same as the belt. The at least two sets of belts may divide the parallel juxtaposed strip-shaped webs into spaced layers. At least two sets of rollers whose center of shaft is adjustable may be used to adjust the transverse position of each layer of strip-shaped web, so that the layers of strip-shaped webs may overlap each other. Then, the overlapped layers of strip-shaped webs may be conveyed into the crosslapper, and may then be processed by the steps of heat treatment and cooling, thereby making a air permeable porous fiber pad.

The web using the heat-melted fiber may be processed by needle punching or water entangling after the crosslap step.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A air permeable porous fiber pad, comprising:
a single-layer or multi-layer web, the web is cut by at least two sets of belt rollers, thereby forming strip-shaped webs whose width is the same as the belt, the at least two sets of belts may divide the parallel juxtaposed strip-shaped webs into spaced layers, at least two sets of rollers whose center of shaft is adjustable may be used to adjust the position of each layer of strip-shaped web, so that the layers of strip-shaped webs may overlap each other, and the overlapped layers of strip-shaped webs may be conveyed into a crosslapper, thereby making a air permeable porous fiber pad.

2. The air permeable porous fiber pad in accordance with claim 1, wherein the web includes a primary fiber of 55% to 85% mixed with a heat-melted fiber of 15% to 45%, thereby forming a raw material which may be processed by opening fiber, blending fiber, hopper, carding, slicing and overlapping, crosslapper, heat treatment, cooling, slicer, and cutting blocks, thereby finally making the air permeable porous fiber pad.

3. The air permeable porous fiber pad in accordance with claim 1, wherein the web includes a primary fiber of 55% to 85%, thereby forming a raw material which may be processed by opening fiber, blending fiber, hopper, carding, slicing and overlapping, crosslap, bonding agent treatment, heat treatment, cooling, slicing, and winding, thereby finally making the air permeable porous fiber pad, the bonding agent treatment may proceed a top side spraying and a bottom side spraying, or dipping resin material of 15% to 45%.

4. The air permeable porous fiber pad in accordance with claim 1, wherein the web is a crimped tow, the crimped tow is opened through the air, so that the single filaments of the crimped tow may be separated, and may be processed by the steps of the crosslap, bonding agent treatment and cooling, thereby making the air permeable porous fiber pad.

5. A method for making a air permeable porous fiber pad, comprising the steps of:
letting a single-layer or multi-layer web to be passed through and cut by at least two sets of belt rollers, thereby forming strip-shaped webs whose width is the same as the belt; the at least two sets of belts may divide the parallel juxtaposed strip-shaped webs into spaced layers, at least two sets of rollers whose center of shaft is adjustable may be used to adjust the position of each layer of strip-shaped web, so that the layers of strip-shaped webs may overlap each other, and the overlapped layers of strip-shaped webs may be conveyed into a crosslapper, thereby making a air permeable porous fiber pad.

6. The air permeable porous fiber pad in accordance with claim 5, wherein the web includes a primary fiber of 55% to 85% mixed with a heat-melted fiber of 15% to 45%, thereby forming a raw material which may be processed by opening fiber, blending fiber, hopper, carding, slicing and overlapping, crosslap, heat treatment, cooling, slicing, and cutting blocks, thereby finally making the air permeable porous fiber pad.

7. The air permeable porous fiber pad in accordance with claim 5, wherein the web includes a primary fiber of 55% to 85%, thereby forming a raw material which may be processed by opening fiber, blending fiber, hopper, carding, slicing and overlapping, crosslap, bonding agent treatment, heat treatment, cooling, slicing, and winding, thereby finally making the air permeable porous fiber pad, the bonding agent treatment may proceed a top side spraying and a bottom side spraying, or dipping resin material of 15% to 45%.

8. The air permeable porous fiber pad in accordance with claim 5, wherein the web is a crimped tow, the crimped tow is opened through the air, so that the single filaments of the crimped tow may be separated, and may be processed by the steps of the crosslap, bonding agent treatment and cooling, thereby making the air permeable porous fiber pad.
